(19) United States
(12) Patent Application Publication
(10) Pub. No.: US 2026/0258783 A1
(43) Pub. Date: Sep. 3, 2026

(54) BLADE FOR A WIND TURBINE AND CONNECTION METHOD FOR CONNECTING SAID BLADE TO A HUB OF SAID WIND TURBINE

(71) Applicant: BLADEWORKS S.R.L., Napoli (IT)

(72) Inventors: Angelo D'ETTORE, Castel Volturno (IT); Michele DAMIANO, Castel Volturno (IT); Ferdinando SCHERILLO, Castel Volturno (IT); Marco MASTROIANNI, Castel Volturno (IT); Mario LONGO, Castel Volturno (IT)

(73) Assignee: BLADEWORKS S.R.L., Napoli (IT)

(21) Appl. No.: 18/846,771

(22) PCT Filed: Mar. 15, 2023
(86) PCT No.: PCT/IB2023/052493

§ 371 Date: Sep. 13, 2024

(30) Foreign Application Priority Data
Mar. 16, 2022 (IT) 102022000005123

(51) Int. Cl. F03D 13/10; F03D 1/06

(52) U.S. Cl. CPC F03D 13/104; F03D 1/0675; F03D 13/112; F05B 2230/60

(57) ABSTRACT

A wind blade for a wind turbine has a tip and a root. The wind blade extends along a first longitudinal axis. The root is suitable for attachment to a hub of a wind turbine. The root has a tubular shape and a base defining a crown extending around the first longitudinal axis. The crown has a plurality of first connection openings spaced apart along the crown. Each first opening has an inner surface defining a first helical coupling portion. In particular, the first helical coupling portion comprises a groove which develops helically to accommodate and allow attaching by screwing a connecting device suitable to attach the root of the blade to the hub.

### CROSS-REFERENCE TO RELATED APPLICATIONS

This Patent Application is a national stage application filed under 35 U.S.C. § 371 of PCT Application No. PCT/IB2023/052493, filed Mar. 15, 2023, which claims priority from Italian Patent Application No. 102022000005123 filed on Mar. 16, 2022, the entire disclosure of each of which is incorporated herein by reference.

### BACKGROUND

### 1. Field of the Disclosure

The present disclosure concerns a blade for a wind turbine and a connection method for connecting the blade to a hub of said wind turbine.

### 2. Description of Related Art

As is known, wind turbines are utilised for converting the energy of an air flow into electric energy. Typically, a wind turbine comprises a rotor provided with a hub and with a plurality of blades connected to the hub; a nacelle connected to the rotor; and a support tower for supporting the nacelle and the rotor. In particular, each blade extends along a longitudinal axis thereof, is hollow, and comprises an end portion called “root” and is configured to be connected to the hub of the rotor. More specifically, the end portion of the blade is shaped as a circular crown and is configured to enter into contact with the outer surface of the hub once the blade is connected to the hub.

During the assembling process of the wind turbine, it is necessary to firmly connect each blade to the hub. Consequently, such connection between the end portion of the blade and the hub is generally carried out by means of the aid of a connecting device.

A currently known connection process provides for embedding a plurality of tubular bodies of the type described in document WO 2015/130162 in the end portion of each blade during the fabrication step of the end portion of the blade. In particular, inside each tubular body a thread is formed so as to allow the coupling with a respective tie rod.

The tie rod is inserted through a respective hole formed in the outer surface of the hub and is screwed within the respective tubular body so as to push the root of the blade against the hub of the wind turbine.

However, the fabrication step of the blade in accordance with the second connection process is complex, costly and requires a considerable working time. Furthermore, during the fabrication step, the tubular bodies can shift from the predefined position, causing misalignments which risk compromising the assembling step of the blade on the hub. In particular in such process, the tubular bodies are embedded in the blade during an intermediate step of the production process of the blade, for example before the infusion of the blade or anyway when the resin with which the blade is fabricated is not completely solidified. This often entails misalignments of the tubular bodies.

### SUMMARY

An object of the present disclosure is to manufacture a blade for a wind turbine which is capable of mitigating the drawbacks of the prior art highlighted herein.

In accordance with the present disclosure, a wind blade for a wind turbine is manufactured; the blade comprising a tip and a root and extending along a first longitudinal axis from the tip to the root; the root being suitable for being attached to a hub of a wind turbine and having a tubular shape and a base in particular hollow which preferably defines a crown, in particular substantially circular or elliptical or ellipsoidal.

The hollow base and/or the crown extend around the first longitudinal axis. On the surface of the hollow base and/or on the crown a plurality of first connection openings are made spaced apart along the hollow base and/or the crown, wherein each first opening extends along a direction substantially parallel to the axis or a direction longitudinal to the extension of the blade.

Each first connection opening having an inner surface which defines a first helical coupling portion, in particular the first helical coupling portion comprises a groove, which develops helically so as to accommodate and allow attaching by screwing a connecting device suitable for attaching the root of the blade to the hub.

Thanks to the present disclosure, it is possible to connect in a reliable, cost-effective and quick manner a blade of a wind turbine to the respective hub.

In this manner, it is possible to insert a connecting device in the blade after completing the fabrication of the blade, in particular when a resin with which the blade is fabricated is already hardened and/or the surfaces of the blade are hard, and it is further possible to choose a posteriori the point of the crown of the base of the blade where to insert each connecting device.

Furthermore, it is possible to carry out the connection between blade and hub without weakening the structure of the blade.

A further object of the present disclosure is to provide a connection method for connecting a blade of a wind turbine to a hub of said wind turbine which is capable of mitigating the drawbacks of the prior art highlighted herein.

In accordance with the present disclosure, a connection method for connecting a blade of a wind turbine to a hub of said wind turbine is provided, the method comprising the steps of:
providing a wind blade having a tubular root with a base in particular hollow and preferably in the shape of a crown preferably circular or elliptical or ellipsoidal; and
making by means of a tapping tool a plurality of first openings on the surface of the base and/or the crown spaced apart along the base and/or the crown, wherein each first opening has an inner surface defining a first helical coupling portion.

Thanks to the present method, it is possible to carry out the connection between blade and hub in a simple, quick and automated manner. In particular, it is possible to select the positions of the end portion of the blade in which to install each connecting device once the fabrication of the blade is completed and after the resin with which the blade is fabricated is hardened without simultaneously making too many holes in the root of the blade which can weaken it.

### BRIEF DESCRIPTION OF THE DRAWINGS

Further characteristics and advantages of the present disclosure will be evident from the following description of non-limiting example embodiments thereof, with reference to the figures of the accompanying drawings.

FIG. 1 is a perspective view, with parts removed for clarity, of a wind turbine manufactured in accordance with the present disclosure.

FIG. 2 is a front view, with parts removed for clarity and with schematic parts, of a blade of the wind turbine of FIG. 1.

FIG. 3 is a section view of a first opening of the blade of FIG. 2 along the cutting plane III-III.

FIG. 4 is a perspective view of a connecting device of the wind turbine of FIG. 1.

FIG. 5 is a side elevation view of the connecting device of FIG. 4.

FIG. 6 is a section view of the connecting device of FIG. 5 along the cutting plane VI-VI.

FIG. 7 is a flowchart of a connection method for connecting a blade of the wind turbine of FIG. 1 to a hub of the wind turbine of FIG. 1, manufactured in accordance with the present disclosure.

### DETAILED DESCRIPTION OF THE DISCLOSURE

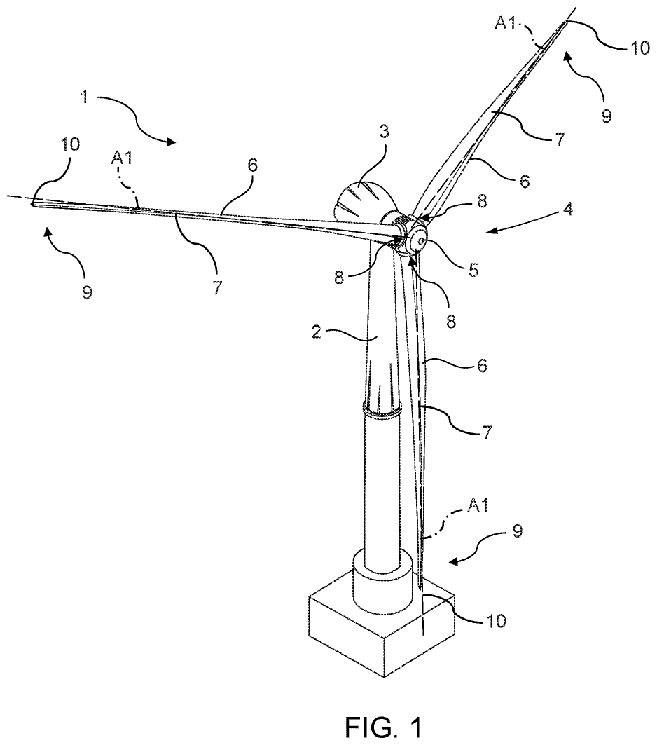

With reference to FIG. 1, reference numeral 1 indicates, as a whole, a wind turbine for converting the energy of an air flow into electric energy in accordance with the present disclosure.

The wind turbine 1 comprises a support tower 2; a nacelle 3 rotatably mounted on top of the support tower 2; a rotor 4, which is rotatably coupled to the nacelle 3 and is provided with a hub 5 and with a plurality of blades 6 connected to the hub 5. In particular, the hub 5 comprises a connection portion (not shown in the accompanying figures) provided with a plurality of openings. In the non-limiting case of the present disclosure described and illustrated herein, the wind turbine 1 comprises three blades 6.

Each blade 6 radially extends from the hub 5 along its own longitudinal axis A1. In particular, each blade 6 comprises a side wall 7, which extends between an end portion connected to the hub 5 and commonly called “root” 8, and an end portion 9 opposite the root 8 and provided with a tip 10.

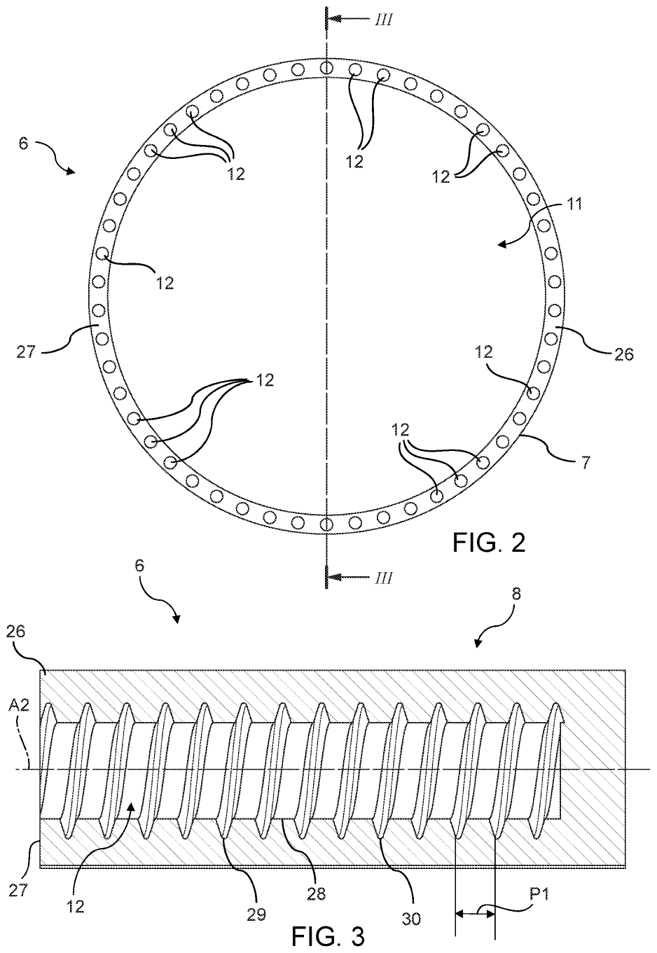

With reference to FIG. 2, the root 8 is suitable to be attached to the hub 5, is tubular in shape and delimits an inner cavity 11. In particular, the root 8 comprises a base 26 which also defines a hollow surface. The base 26 defines a substantially circular crown 27 which extends around the longitudinal axis A1. More specifically, the base 26 of the root 8 is configured to enter into contact with an outer surface of the hub 5 when the blade 6 is connected to the hub 5.

In accordance with further embodiments of the present disclosure, not shown in the accompanying figures, the crown 27 can assume different shapes among which a substantially elliptical or ellipsoidal shape.

In accordance with the present disclosure, the base 26 is provided with a plurality of connection openings 12 spaced apart along the crown 27. Each opening 12 extends in a direction substantially parallel to the longitudinal axis A1 of the blade 6 or in a direction longitudinal to the extension of the blade 6.

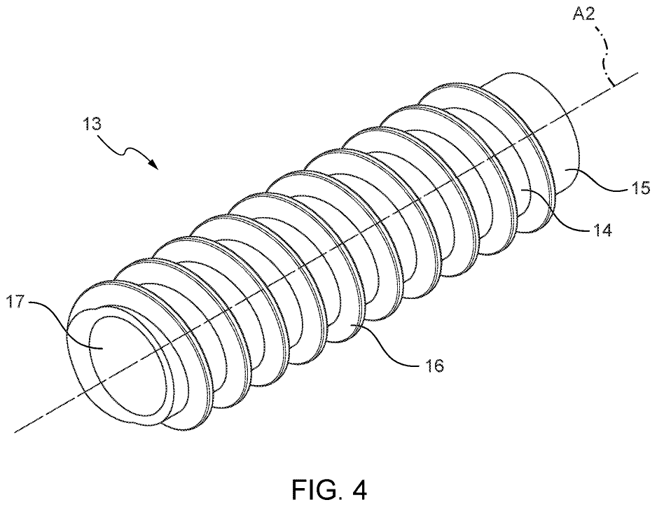

With reference to FIG. 3, each opening 12 has an inner surface 28 which defines a helical coupling portion 29. In particular, the helical coupling portion 29 comprises a groove 30, which develops helically so as to accommodate and allow attaching by screwing a connecting device 13 (FIGS. 3-5) suitable to attach the root 8 of the blade 6 to the hub 5.

More specifically, a section of the helical coupling portion 29 along a cutting plane III-III on which the longitudinal axis A1 lies is substantially trapezoidal in shape, preferably shaped as an isosceles trapezoid.

In accordance with a non-limiting embodiment of the present disclosure, the major base of said substantially trapezoidal shape has a length comprised between 2 millimetres and 50 millimetres. The minor base of said substantially trapezoidal shape has a length comprised between 1 millimetre and 40 millimetres. The height of said substantially trapezoidal shape has a length comprised between 3 millimetres and 80 millimetres.

In particular, said substantially trapezoidal shape has a circular bulk with a length comprised between 20 millimetres and 300 millimetres.

More specifically, each angle of said substantially trapezoidal shape is bevelled.

It is understood that, in accordance with the present disclosure, said section can also assume different shapes. By way of example, in accordance with an alternative embodiment of the present disclosure, said section is substantially triangular in shape, preferably shaped as an isosceles triangle, or shaped as a sawtooth.

Furthermore, the helical coupling portion 29 has a pitch P1 having a length comprised between 5 millimetres and 150 millimetres.

It is understood that the term “pitch”, referred to the helical coupling portion 29, means the length of the distance measured along the longitudinal axis A1 between a portion of the groove 30 and the following portion of the groove 30.

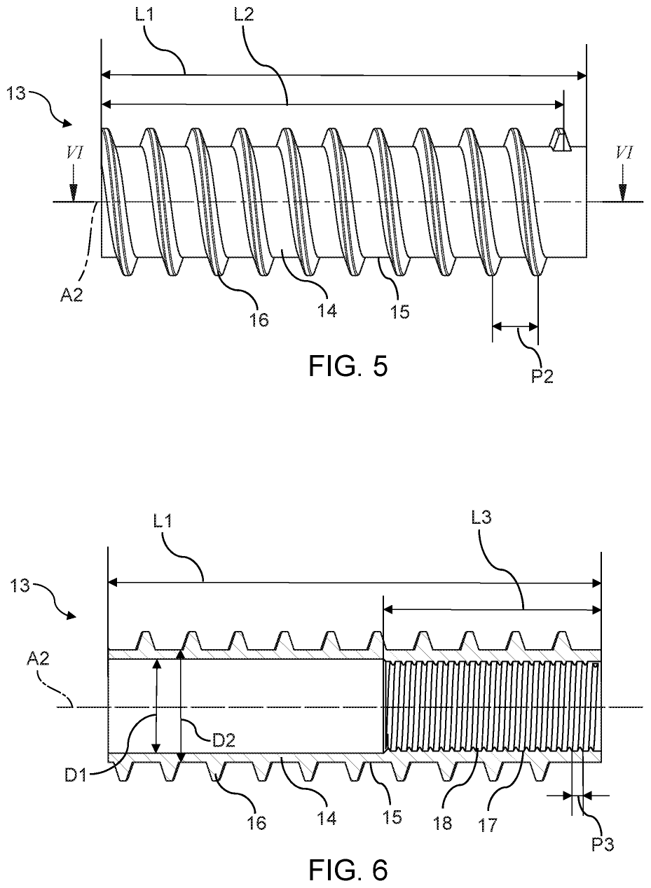

With reference to FIGS. 4 and 5, a connecting device 13 for connecting each blade 6 to the hub 5 is shown. The connecting device 13 comprises an elongated body 14, which extends along a longitudinal axis A2 and has an outer portion of cylindrical surface 15, which is provided with a helical coupling portion 16 configured to mate with the helical coupling portion 29 formed in at least one of the openings 12.

In particular, the elongated body 14 is tubular in shape and extends around the longitudinal axis A2.

More specifically, the helical coupling portion 16 is in relief from the portion of cylindrical surface 15. In this manner, the helical coupling portion 16 can slide inside the groove 30 of the helical coupling portion 29 when the connecting device 13 is screwed within the respective opening 12.

With reference to FIG. 6, a section of the helical coupling portion 16 along a cutting plane VI-VI on which the longitudinal axis A2 lies is substantially trapezoidal in shape. In particular, said section is shaped as an isosceles trapezoid.

In accordance with a non-limiting embodiment of the present disclosure, the major base of said substantially trapezoidal shape has a length comprised between 2 millimetres and 50 millimetres. The minor base of said substantially trapezoidal shape has a length comprised between 1 millimetre and 40 millimetres. The height of said substantially trapezoidal shape has a length comprised between 3 millimetres and 80 millimetres.

In particular, said substantially trapezoidal shape has a circular bulk with a length comprised between 20 millimetres and 300 millimetres.

More specifically, each angle of said substantially trapezoidal shape is bevelled.

It is understood that, in accordance with the present disclosure, said section can also assume different shapes. By way of example, in accordance with an alternative embodiment of the present disclosure, said section is substantially triangular in shape, preferably shaped as an isosceles triangle, or shaped as a sawtooth.

Furthermore, the elongated body 14 has an inner portion of cylindrical surface 17, on which a helical coupling portion 18 is formed configured to mate with a complementary coupling portion of a tie rod (not shown in the accompanying). In particular, each helical coupling portion 18 is configured to mate with a tie rod inserted inside a respective opening 12 and a respective opening of the connection portion of the hub 5.

In accordance with an embodiment of the present disclosure, not shown in the accompanying figures, the elongated body 14 is substantially cylindrical in shape. In such configuration, the portion of cylindrical surface 15 and the portion of cylindrical surface 17 are arranged at opposite ends of the elongated body 14.

In accordance with the present disclosure, the helical coupling portion 16 has a pitch P2 and the helical coupling portion 18 has a pitch P3. The pitch P2 and the pitch P3 are of different lengths. In particular, the length of the pitch P2 is greater than the length of the pitch P3.

More specifically, the helical coupling portion 16 has a pitch P2 with a length comprised between 5 millimetres and 50 millimetres.

More specifically, the helical coupling portion 16 has a pitch P3 with a length comprised between 1 millimetre and 20 millimetres.

It is understood that the term “pitch”, referred to the helical coupling portions 16 and 18, means the length of the distance measured along the longitudinal axis A2 between a relief from the helical coupling portion 16 or from the helical coupling portion 18 and the following relief from the helical coupling portion 16 or from the helical coupling portion 18, respectively.

In the case described and illustrated herein, the elongated body 14 has a length L1 measured along the longitudinal axis A2. The helical coupling portion 16 extends on the portion of cylindrical surface 15 for a length L2 measured along the longitudinal axis A2, wherein the length L2 is less than the length L1.

In other words, the helical coupling portion 16 extends on the portion of cylindrical surface 15 only for a part of the total length L1 of the elongated body 14.

Furthermore, the helical coupling portion 18 extends on the portion of cylindrical surface 17 for a length L3 measured along the longitudinal axis A2, wherein the length L3 is less than the length L1.

In other words, the helical coupling portion 18 extends on the portion of cylindrical surface 17 only for a part of the total length L1 of the elongated body 14.

In accordance with a non-limiting embodiment of the present disclosure, the elongated body 14 tubular in shape has an inner diameter D1 with dimensions comprised between 15 and 120 millimetres. Furthermore, the elongated body 14 tubular in shape has an outer diameter D2 with dimensions comprised between 17 and 170 millimetres, in particular from 19 mm to 160 mm. In other words, the thickness of the elongated body 14 tubular in shape is comprised between 1 and 25 millimetres, in particular the thickness measured in a point of the tubular of the elongated body 14.

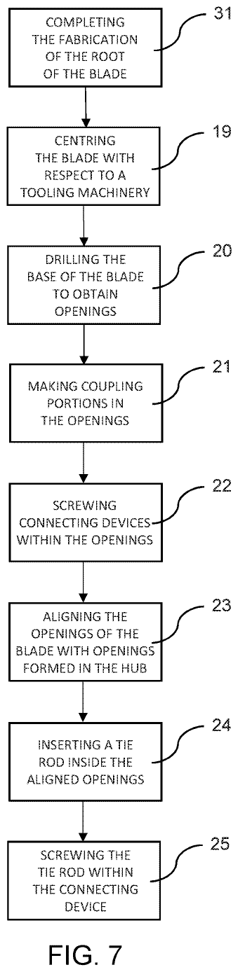

With reference to FIG. 7, a flowchart of a connection method for connecting each blade 6 of the wind turbine 1 to the hub 5 is shown.

The connection method comprises the step of completing the fabrication of the root 8 of the blade 6 (block 31), preferably so that the base 26 of the root 8 of the blade 6 extends in a crown around the longitudinal axis A1.

Subsequently, the connection method comprises the steps of arranging the blade 6 in a drilling/tapping station so as to centre the blade 6 with respect to a drilling/tapping machine (block 19) and drilling the base 26 of the blade 6 (block 20) so as to obtain a plurality of openings 12 along the crown 27 (FIG. 2). By way of example, the drilling step can be carried out by a numerically controlled machine or by a robot or by personnel.

In other words, the drilling/tapping steps are performed on a blade whose resin is already hardened and when all the parts defining the outer surfaces of the blade are already assembled, i.e. when the blade already has the hollow shape and the outer surface already defines a circular outer surface. In other words, if the blade is defined by two half shells glued together, the drilling/tapping step is carried out after the two half shells are glued together. Whereas, if the blade is defined by means of a single production process of the outer surfaces of the blade, the drilling/tapping step is carried out after the single production process of the blade is completed and the surfaces of the blade already define a tubular body.

Subsequently, the helical coupling portion 29 is made inside each opening 12 by means of a tapping tool (block 21).

In particular, the manufactured helical coupling portion 29 has a helical groove 30 complementary to the helical coupling portion 16 of the connecting device 13.

More specifically, each helical coupling portion 29 is manufactured by a numerically controlled machine or by a robot or by personnel.

Once the drilling and tapping operations are completed, each connecting device 13 (FIGS. 3-5) is screwed within the respective opening 12 (block 22), preferably so that the longitudinal axis A2 of each connection body 13 is substantially parallel to the longitudinal axis A1 of the blade 6.

In particular, during the screwing of the connecting device 13 in the respective opening 12, the helical coupling portion 16 slides inside the groove 30 of the helical coupling portion 29 of the respective opening 12.

Preferably, before screwing the connecting device 13 within the respective opening 12, an interface material is arranged on the coupling portion 16 so as to act as threadlocker during the screwing of the connecting device 13 within the respective opening 12.

Once the connecting devices 13 are screwed, the root 8 of the blade 6 is arranged at a connection portion of the hub 5 provided with further openings, so that the openings 12 are aligned with said further openings (block 23).

Subsequently, a tie rod, not shown in the accompanying figures, is inserted inside each opening 12 and each further opening (block 24), and is screwed within the elongated body 14 of the respective connecting device 13 so as to push the root 8 of the blade 6 against the hub 5 of the wind turbine 1 (block 25).

Finally, it is evident that the present disclosure comprises further variations of the described embodiments included within the scope of protection of the appended claims.

1. A wind blade for a wind turbine, the blade comprising:
a tip; and
a root,
wherein the blade extends along a first longitudinal axis from the tip to the root,
wherein the root is suitable for attachment to a hub of a wind turbine,
wherein the root has a tubular shape and a defining a crown extending around the first longitudinal axis,
wherein the crown has a plurality of first connection openings that are spaced apart along the crown,
wherein each first opening extends along a direction substantially parallel to the first longitudinal axis or a direction longitudinal to the extension of the blade, and
wherein each first opening has an inner surface defining a first helical coupling portion which develops helically to accommodate and allow attaching by screwing a connecting device suitable to attach the root of the blade to the hub.

2. The blade as claimed in claim 1, wherein the first helical coupling portion has a section along a first cutting plane on which the first longitudinal axis lies that is substantially trapezoidal in shape, substantially triangular in shape, or shaped as a sawtooth.

3. The blade as claimed in claim 1, wherein the first helical coupling portion has a first pitch having a length between 5 millimetres and 150 millimetres.

4. The blade as claimed in claim 1, further comprising:
a connecting device for each first connection opening configured to connect the root of the blade to the hub,
wherein each connecting device comprises an elongated body that extends along a second longitudinal axis and each connecting device has:
a first cylindrical surface portion, which is provided with a second helical coupling portion configured to mate with the first helical coupling portion formed in at least one of the first openings of the blade; and
a second cylindrical surface portion, on which a third helical coupling portion is formed, configured to mate with a complementary coupling portion of a tie rod.

5. The blade as claimed in claim 4,
wherein the elongated body is tubular in shape and extends around the second longitudinal axis,
wherein the first cylindrical surface portion is external, and
wherein the second cylindrical surface portion is internal.

6. blade as claimed in claim 4,
wherein the second helical coupling portion has a second pitch,
wherein the third coupling portion has a third pitch, and
wherein the second pitch and the third pitch have different lengths.

7. The blade as claimed in claim 4, wherein the second helical coupling portion is raised relative to the first cylindrical surface portion.

8. The blade as claimed in claim 4, wherein the second helical coupling portion has a section along a second cutting plane on which the second longitudinal axis lies that is substantially trapezoidal in shape, substantially triangular in shape, or shaped as a sawtooth.

9. The blade as claimed in claim 4, wherein the second helical coupling portion and the third helical coupling portion are arranged at opposite ends of the elongated body.

10. The blade as claimed in claim 4, wherein the second helical coupling portion and the third helical coupling portion are arranged at the same end of the elongated body.

11. A rotor of a wind turbine, the rotor comprising:
a plurality of blades as claimed in claim 1; and
the hub,
wherein the hub comprises a connection portion provided with a plurality of second openings coupled to the plurality of connecting devices to connect each blade to the hub.

12. A wind turbine, the turbine comprising:
a support tower;
a nacelle supported by the support tower; and
the rotor as claimed in claim 11,
wherein the rotor is rotatably coupled to the nacelle.

13. A connection method for connecting a blade of a wind turbine to a hub of said wind turbine, the method comprising the steps of:
providing a wind blade having a root with a base in the shape of a crown; and
making, with a tool, a plurality of first openings on a surface of the crown,
wherein the plurality of first openings are spaced apart along the crown, and
wherein each first opening has an inner surface defining a first helical coupling portion.

14. The method as claimed in claim 13, wherein each first helical coupling portion is made by a numerically controlled machine, or by a robot, or manuallyby personnel.

15. The method as claimed in claim 13, wherein each first helical coupling portion has a helical groove.

16. The method as claimed in claim 13, further comprising the step of:
screwing a connecting device comprising an elongated body in each first opening.

17. The method as claimed in claim 16, further comprising the steps of:
arranging the base of the root of the blade at a connection portion of the hub provided with second openings so that the first openings are aligned with the second openings;
inserting a tie rod inside each aligned first opening and second opening; and
screwing each tie rod onto the elongated body of the respective connecting device to push the root of the blade against the hub of the wind turbine.

18. The method as claimed in claim 13, further comprising the step of:
drilling the base of the blade to obtain the plurality of first openings before making the respective first helical coupling portions.

19. The method as claimed in claim 13, further comprising the step of:
arranging the blade in a drilling and/or tapping station to center the blade with respect to a drilling and/or tapping machine.

20. The method as claimed in claim 13, further comprising the step of:
completing fabrication of the root of the blade and subsequently making the first helical coupling portions.

21. The method as claimed in claim 17,
wherein the connecting device comprises an elongated body having a tubular shape, which has an external first cylindrical surface portion provided with a second helical coupling portion configured to couple with the first helical coupling portion of the respective first opening, and
wherein the connecting device comprises an internal second cylindrical surface portion, on which a third helical coupling portion is formed, configured to mate with a complementary coupling portion of the tie rod.

22. The method as claimed in claim 21, wherein the second helical coupling portion is raised relative to the first portion of cylindrical surface.
